(19) United States
(12) Patent Application Publication
(10) Pub. No.: US 2007/0217347 A1
(43) Pub. Date: Sep. 20, 2007

(54) Method and Devices for Providing a Push-to-Talk-Connection Between at Least Two User Terminals in a Communications Network

(76) Inventors: Manfred Leitgeb, Gramatneusiedl (AT); Peter Markovics, Zistersdorf (AT); Erwin Postmann, Forchtenstein (AT); Jorg Swetina, Wien (AT)

Correspondence Address: STAAS & HALSEY LLP, SUITE 700, 1201 NEW YORK AVENUE, N.W., WASHINGTON, DC, 20005, US

(21) Appl. No.: 10/594,077

(22) PCT Filed: Jan. 24, 2005
(86) PCT No.: PCT/EP05/50284

§ 371 Date: Sep. 25, 2006

(30) Foreign Application Priority Data
Mar. 24, 2004 (DE) 10200401440.0

(51) Int. Cl. H04L 12/16

(52) U.S. Cl. 370/263

(57) ABSTRACT

By signalling information for establishing the push-to-talk communication of a first terminal with a switching node in a mobile telecommunications network, establishing a usable link with the switching node from the first terminal and then establishing a usable link with at least one other terminal from the switching node, a push-to-talk connection is established.

### CROSS REFERENCE TO RELATED APPLICATIONS

This application is based on and hereby claims priority to German Application No. 10 2004 014 440.0 filed on Mar. 24, 2004, the contents of which are hereby incorporated by reference.

### BACKGROUND

A method and devices for providing a push-to-talk connection between at least two user terminals in a communications network, especially a mobile communications network, are described.

A “walkie-talkie” form of communication between telecommunications users is known as push-to-talk, or P2T. In this type of communication GSM users as well as the current technical situation are taken into account. Pressing a “speak key” should make it possible for a user to communicate with other users. Communication is between individuals or is possible within a group of people.

Previously in GSM technology there have merely been voice connections for person-to-person communication or conference calls. This involves seizing telecommunications links for the duration of the call and each user can them simultaneously talk and listen. A “walkie-talkie” form of communication is not known. The only similar form of communication according to the GSM standard is known as “Advanced Speech Call Items” but these are restricted however to defined small geographical areas and primarily take account of the requirements of “authorities”.

### SUMMARY

An aspect is to make possible a push-to-talk connection between at least two user terminals within a communication network using circuit switched connections.

An important aspect is a method for providing a push-to-talk-connection between at least two user terminals in a communications network, especially a mobile communications network, whereby
a) Information is signaled from a first terminal to set up a push-to-talk connection to a switching node,
b) A payload connection is established from the first terminal to the switching node and
c) A payload connection to at least one further terminal is established from the switching node.

A further aspect is executing the above-mentioned method using a terminal and a switching node.

Preferably the USSD (Unstructured Supplementary Service Data) protocol is used for signaling the information to set up a push-to-talk-connection.

It is conceivable for the above steps a) and b) to be executed in the reverse order, with the UUS (User-to-User Signaling) protocol then preferably being used for signaling.

The method takes account of the current state of the widely-used GSM technology and in doing so especially uses the GSM options of “circuit switched” connections as its basis.

This technology has existed since the introduction of GSM and is used by approximately 1 billion GSM users worldwide. Mobile radio devices normally used nowadays have a “SIM Tool Kit” technology facility. In this technology it is possible to load new applications over the GSM air interface onto a GSM terminal and to configure applications already located on the terminal.

A “P2T client” must first be loaded on a GSM terminal. This P2T client offers the user additional menu options on the terminal to enable the P2T solution to be used, typically a softkey to control the connection and options for administering other P2T users. A P2T connection is established by the user selecting the P2T connection target on his P2T client. In such cases it makes no difference whether one or more connection targets are selected.

After selection of the connection targets on the P2T client, this client sends a USSD (Unstructured Supplementary Service Data) message with the connection target(s) to the network. The USSD message is resolved at the HLR and forwarded to a switching node, preferably to a P2T Conference Server. At the P2T Conference Server the message is analyzed and acknowledged. Through the receipt of the USSD message at the P2T Conference Server resources are seized preventively for the P2T connection. The acknowledgement is returned to the P2T client. A known CS connection (with predefined destination=P2T Conference Server) is now established automatically by the P2T client. The predefined destination can be selected at the P2T client by the operator.

After the CS connection is received at the P2T Conference Server a connection or connections is or are established to the individual connection destinations (which were analyzed by the previous USSD message). In this case CS connections are again involved.

Alternatively, after the connections have been selected at the P2T client a CS connection (with predefined destination=P2T Conference Server) can be set up from the P2T client. [the predefined destination can be selected at the P2T client by the operator]. In the course of establishing this connection the previously selected connection destinations are then notified by the User-to-User Signaling Service 1, to the P2T Conference Server. After receipt of the CS connection at the P2T Conference Server connections are established to the individual connection destinations (which are analyzed from the UUS additional data in the connection setup). In this case CS connections are again involved.

Each individually called user receives an incoming call, with the P2T already displaying to the called user the fact that a “P2T invitation” exists. This is desirable in order to distinguish between P2T invitations and normal incoming CS connections. As a distinguishing feature the P2T client analyzes the “calling line identity” and if this involves the known P2T Conference Server Identity, the P2T client knows that a P2T invitation is involved.

The invited user accepts the invitation, ignores it or rejects it. All further users are “invited” in the same manner. If the invited user accepts the invitation, this is acknowledged and the CS connection switched through to the P2T Conference Server and the invited user immediately hears the communication.

At the beginning of the P2T communication the speech of the inviting party is merely distributed via the P2T Conference Server and heard by all invited parties. However each P2T user is free to make a request for authorization to speak. These requirements are received and processed at the P2T Conference Server.

At any point in time of the P2T communication only a single user is ever allowed, to speak or the speech stream of a user is distributed to all other users. If the person speaking ends his flow of speech, by “releasing” the speak button, this process is transmitted by a USSD message or by a UUS Service 2 message with corresponding contents to the P2T Conference Server. If a user requests a speech authorization, the P2T client sends a USSD message or UUS Service 2 message with the corresponding contents to the P2T Conference Server. All users are informed about each change of the speech authorization. If a user clears his connection to the P2T Conference Server all users are informed. If the original inviting user clears his connection to the P2T Conference Server the entire P2T communication is cleared.

The functions of the P2T client and of the Conference Server are described below.
Functions of the P2T client:

For connection setup (outgoing call):
Sends as alternatives
   List of users
   Number of the P2T conference
via USSD or via UUS Service 1 to the (fixed) Conference Server.
   Connection setup to the Conference Server.

For connection setup (incoming call):
Detects on the basis of the CLI of the Conference Server that a P2T connection is involved and switches to menu prompts on the P2T.
Displays P2T-relevant incoming USSD or UUS Service 1 messages.
Shows other incoming calls (and places these on hold).

During the P2T connection:
Sends request for speech authorization to the Conference Server.
Receives speech authorization and other messages (e.g. newly connected users) by USSD or by UUS Service 2 from the Conference Server.

Tasks of the Conference Server:
Receives USSD or UUS of the initiating user with
   The list the other user to be invited or
   Number of the P2T conference.
Dials these other users. In this case P2T-relevant information (e.g. user list, number of the P2T conference . . . ) is notified by USSD or by UUS.
Only through-connects the uplink speech channel of the person who has speech authorization.
Signals speech authorization and other P2T messages (e.g. entry and exit of the users into and from the P2T conference) by USSD or by UUS to all users.
Clears P2T conference if initiating user leaves the conference.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 a schematic diagram of a typical network configuration in which the USSD protocol is used and

FIG. 2 a schematic diagram of a typical network configuration in which the UUS protocol is used.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The labels are identical for the network elements in the two figures: TE for a terminal, BTS for a base station, BSC for a base station controller, SAT Server for a SIM Application Toolkit Server, HLR for a Home Location Register, Conference Server for the switching node, in the example a conference server, MSC for a Mobile Switching Center. The numbers in the circles identify the method as follows.

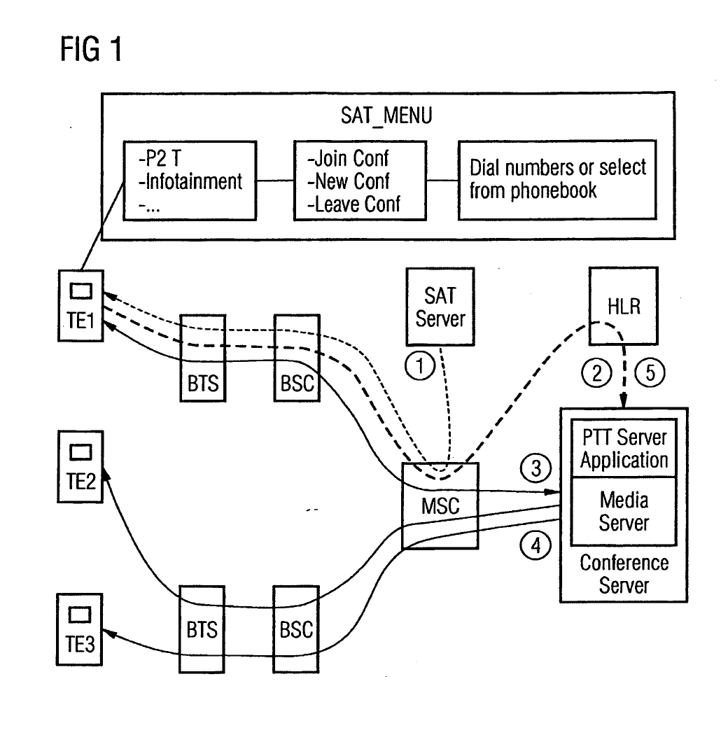

The method shown in FIG. 1 is:
1. Loading the P2T client application on terminal TE1, using “SIM Application Toolkit” (SAT) technology.
2. All the necessary information for setting up the P2T connection(s) to one or more terminal users TE2, TE3 is signaled by USSD to the P2T Conference Server.
3. After the P2T Conference Server has acknowledged the USSD message, a speech connection is established to it.
4. The server now established speech connection(s) to the desired terminal users TE2, TE3.
5. The initiator terminal TE1 of the P2T communication now ends the session by USSD.

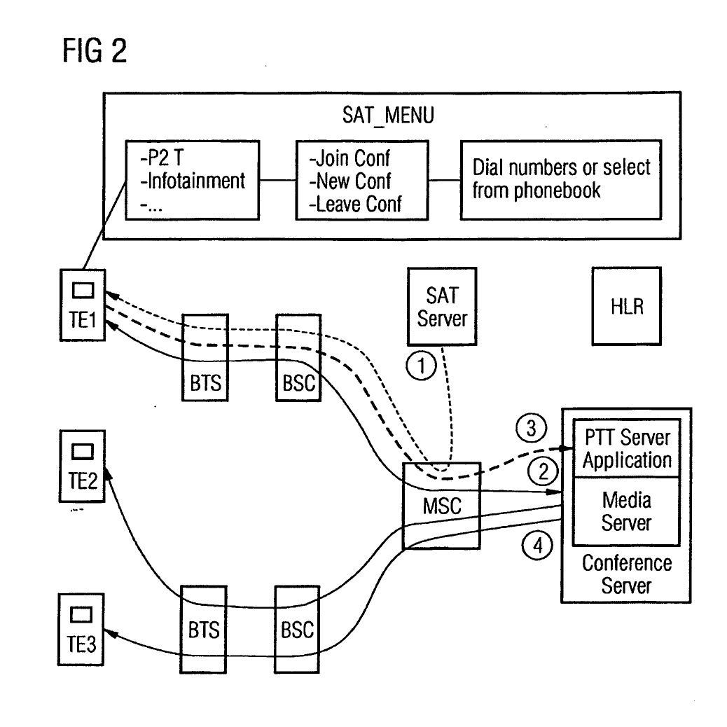

The method shown in FIG. 2 is:
1. Loading the P2T client application on terminal TE1, using “SIM Application Toolkit” (SAT) technology.
2. The initiator of the P2T session establishes a speech connection to the P2T Conference Server.
3. All the necessary information for setting up the P2T connection(s) to one or more other terminal users TE2, TE3 is signaled by USS to the P2T Conference Server.
4. The P2T Conference Server analyzes the UUS message and establishes a speech connection to the desired terminal(s) TE2, TE3.

At the initiator terminal TE1 of the P2T communication the conference is ended by going on-hook.

Preferred embodiments and examples have been described in detail, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-17. (canceled)

18. A method for providing a push-to-talk connection between at least two user terminals in a communications network, comprising
signaling information from a first terminal to set up a push-to-talk connection to a switching node;
establishing a usable link from the first terminal to the switching node; and
establishing a usable link from the switching node to at least one further terminal.

19. A method as claimed in claim 18, wherein useable links established are speech connections.

20. A method as claimed in claim 19, wherein the communications network is a mobile communications network.

21. A method as claimed in claim 20, wherein at least one terminal is represented by a mobile terminal.

22. A method as claimed claim 21, wherein the information is signaled by means of USSD.

23. A method as claimed in claim 22, wherein the usable link from the first terminal to the switching node is established before setting up the push-to-talk connection to the switching node.

24. A method as claimed in claim 23, wherein the information is signaled by UUS.

25. A method as claimed in claim 24, further comprising initiating ending of the useable link by one of the first terminal and the at least one other terminal.

26. A method as claimed in claim 25, further comprising acknowledging receipt of the signaled information by the switching node.

27. A method as claimed in claim 26, further comprising loading application software onto the first terminal prior to initiating the push-to-talk connection.

28. A terminal for push-to-talk communication with at least one other user terminal in a communications network having a switching node, comprising:
means for signaling information to the switching node to set up a push-to-talk connection to the switching node;
means for establishing a usable link to the switching node; and
means for requesting a usable link from the switching node to at the least one other terminal.

29. A terminal as claimed in claim 28, wherein said means for signaling information uses USSD or UUS.

30. A terminal as claimed in claim 29, further comprising means for loading application software for initiating a push-to-talk connection.

31. A switching node in a communications network for push-to-talk communication between at least two user terminals, comprising:
means for receiving signaling information from a first terminal to set up a push-to-talk connection; and
means for establishing usable links to the first terminal and at least one other terminal.

32. A switching node as claimed in claim 31, further comprising means for acknowledging the signaling information.

33. A switching node as claimed in claim 32, further comprising means for controlling the push-to-talk connection.

34. A switching node as claimed in claim 33, wherein said means for controlling uses USSD or UUS.
